(19) United States
(12) Patent Application Publication
(10) Pub. No.: US 2019/0318375 A1
(43) Pub. Date: Oct. 17, 2019

(54) SMART PAYMENT SOLUTION

(71) Applicant: EBAY KOREA CO., LTD., SEOUL (KR)

(72) Inventor: Chul Hoon Choi, Seoul (KR)

(21) Appl. No.: 15/969,983

(22) Filed: May 3, 2018

Related U.S. Application Data
(63) Continuation of application No. 15/954,142, filed on Apr. 16, 2018.

(51) Int. Cl. G06Q 30/02; G06Q 30/06

(52) U.S. Cl. CPC G06Q 30/0222; G06Q 30/0635; G06Q 20/227

(57) ABSTRACT

One or more processors access a user profile associated with a set of payment methods, the user profile being associated with a user. The one or more processors receive a selection of a plurality of items for purchase by the user and access information for a plurality of coupons. A user interface is presented that includes for each payment method of the set of payment methods, a total cost for the plurality of items; a recommended payment method selected from the set of payment methods; and a recommended assignment of the coupons to the items. The one or more processors receive a confirmation from the user and initiate a purchase transaction for the items by the user, the purchase transaction using the recommended payment method and the recommended assignment of the coupons to the items.

### PRIORITY CLAIM

This application is a continuation of and claims the benefit of priority to U.S. patent application Ser. No. 15/954,142, filed Apr. 16, 2018, and titled “Smart Payment Solution,” which application is incorporated herein by reference in its entirety.

### TECHNICAL FIELD

The subject matter disclosed herein generally relates to improved user interfaces. Specifically, in some example embodiments, the present disclosure addresses systems and methods, including user interfaces, for automatically selecting coupons, discounts, and payment methods to apply to item purchases.

### BACKGROUND

An online marketplace may provide a user with a number of different discounts of different types with conditions for application of each discount. Some of the discounts may be mutually exclusive. The user may be faced with a complex and time-consuming task of applying the discounts to items for purchase.

### BRIEF DESCRIPTION OF THE DRAWINGS

Some embodiments are illustrated by way of example and not limitation in the figures of the accompanying drawings.

FIG. 1 is a network diagram illustrating a network environment suitable for a smart payment solution, according to some example embodiments.

FIG. 2 is a block diagram illustrating components of an e-commerce server suitable for a smart payment solution, according to some example embodiments.

FIG. 3 is a block diagram illustrating a user interface suitable for accepting a recommended set of payment and discount options, according to some example embodiments.

FIG. 4 is a block diagram illustrating a user interface suitable for accepting a recommended set of payment and discount options, according to some example embodiments.

FIG. 5 is a block diagram illustrating a user interface suitable for accepting a recommended set of payment and discount options, according to some example embodiments.

FIG. 6 is a block diagram illustrating a user interface suitable for accepting a recommended set of payment and discount options, according to some example embodiments.

FIG. 7 is a block diagram illustrating a user interface suitable for setting user options, according to some example embodiments.

FIGS. 8 and 9 are block diagrams illustrating a database schema suitable for a smart payment solution, according to some example embodiments.

FIG. 10 is a flowchart illustrating operations of a computing device in performing a method of generating a solution to a multidimensional assignment problem, according to some example embodiments.

FIG. 11 is a flowchart illustrating operations of an e-commerce server in performing a method of recommending a set of payment and discount options, according to some example embodiments.

FIG. 12 is a flowchart illustrating operations of an e-commerce server in performing a method of recommending a set of payment and discount options, according to some example embodiments.

FIG. 13 is a block diagram illustrating an example of a software architecture that may be installed on a machine, according to sonic example embodiments.

FIG. 14 is a diagrammatic representation of a machine in the form of a computer system within which a set of instructions may be executed for causing the machine to perform any one or more of the methodologies discussed herein, according to an example embodiment.

### DETAILED DESCRIPTION

Example methods and systems are directed to smart payment solutions. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A user of an online marketplace selects items for purchase and places them in a virtual shopping cart. The user may have access to a number of discounts, each discount associated with a set of criteria that define when the discount may be applied. Some discounts may be limited to application to any one item in the shopping cart. Other discounts may apply only when a particular payment option (e.g., a specific credit card) is used for payment. Still other discounts may apply only to a single item that meets additional criteria (e.g., meets or exceeds a minimum price, is of a particular category of product, is of a particular brand, or any suitable combination thereof).

To generate a proposed application of the discounts to the items in the shopping cart, every possible combination of discounts may be considered and the resulting lowest price selected. However, the computational power to consider every possibility is significant. For example, if a user's shopping cart contains 30 items and the user has 30 buyer coupons that may have a one-to-one relationship with an item, the number of possible assignments of buyer coupons to items is over 10³³. If the user further has 30 duplicate coupons that may be used with the buyer coupons but not with each other, the number of possible assignments of duplicate coupons to the items is also over 10³³. The total number of possible assignments of buyer coupons and duplicate coupons would exceed 2×10³³, and considering the possibility of different discounts being available for different payment methods available to the user increases the number of possibilities even more. For example, with four payment methods, the total number of possible solutions would exceed 8×10³³.

Using the systems and methods described herein, the problem is decomposed by payment method, resulting in a simpler optimization problem for each payment method. Thus, one proposed combination of discounts is generated for each payment method. The proposed combination of discounts resulting in the lowest price is proposed to the user, along with the corresponding payment method.

Historically, assignment of coupons to items is a manual process. The user would select each coupon and the item to which it would be applied. When the user has a large number of coupons and items, the puzzle of assigning coupons to items in a way that maximizes the user's discount can be time-consuming and error-prone. With the systems and methods described herein, the system optimizes the combination of discounts to generate a proposed assignment of coupons to items and allows the user to accept the proposed assignment. Thus, the user interface by which a user instructs the online marketplace to assign discounts to items is improved.

Another aspect of the systems and methods described herein is reduced processing and memory storage on the user's device. In the existing methods of assigning coupons to items, the user's device's processing power, display device, and memory storage are used to present and update a user interface by which the user assigns coupons to items. By rapidly generating the proposed combination on a server and transferring the proposed combination to the user's device, the systems and methods described herein reduce power consumption and memory storage usage on the user's device. When the user's device is battery-powered (e.g., is a smart phone or tablet), this power savings may result in increased operation time.

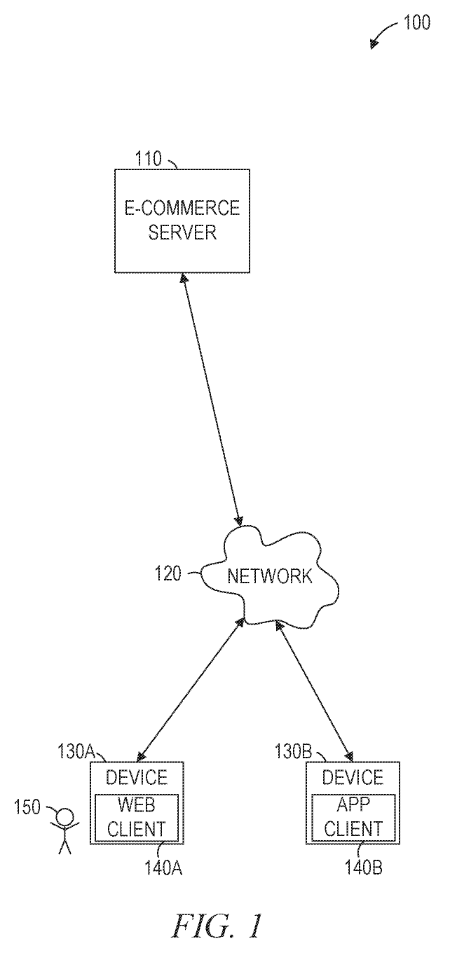

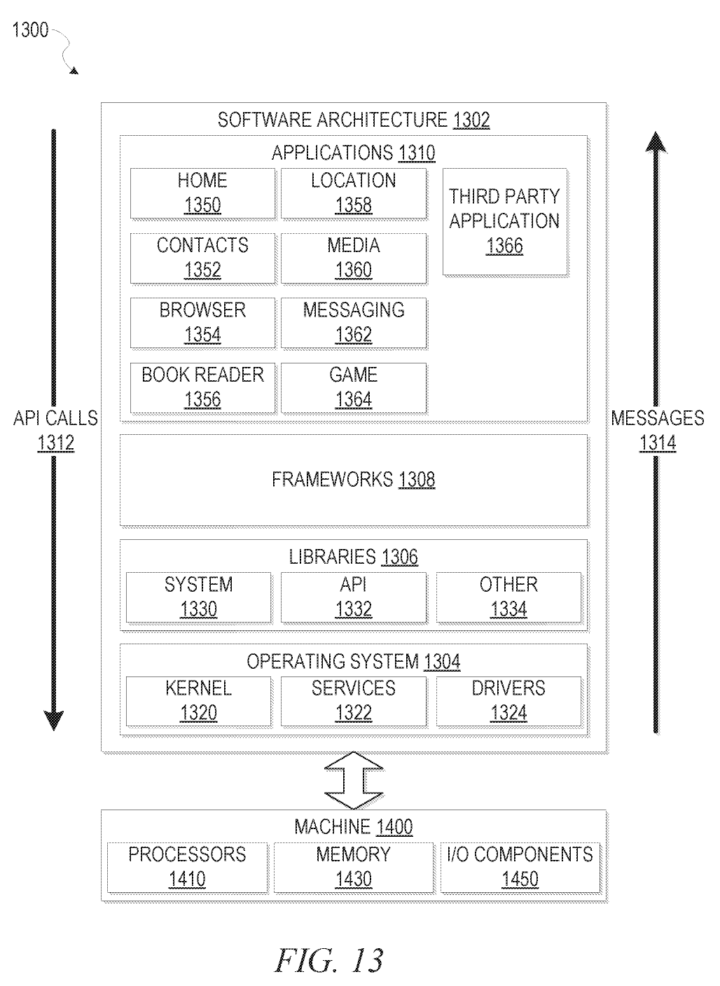

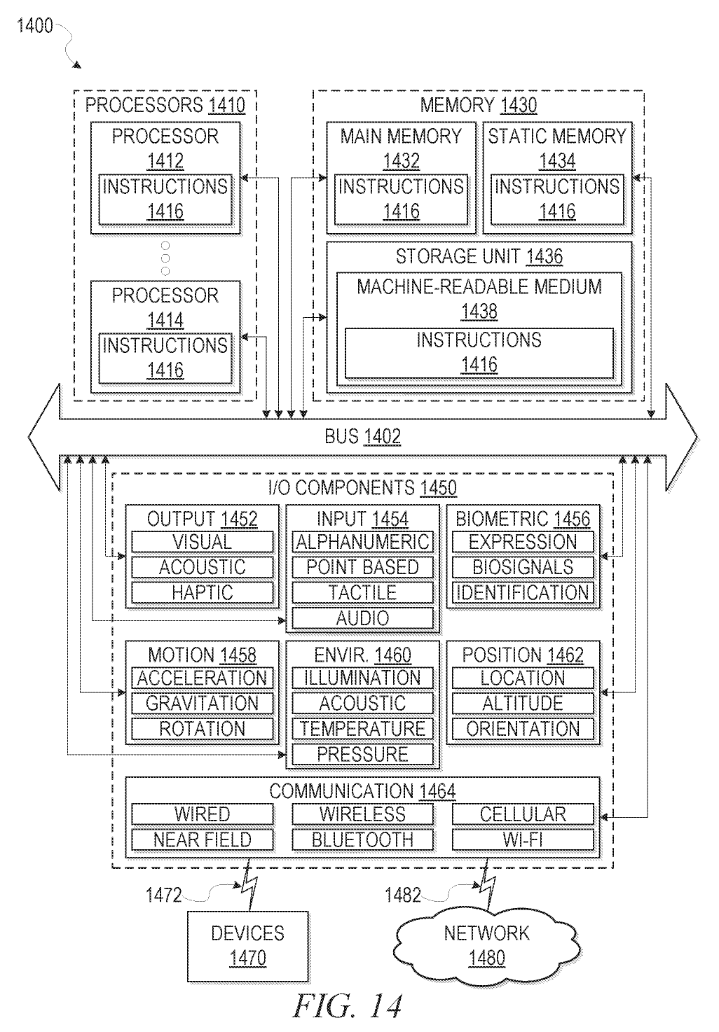

FIG. 1 is a network diagram illustrating a network environment 100 suitable for a smart payment solution, according to some example embodiments. The network environment 100 includes an e-commerce server 110, device 130A, and device 13013, all communicatively coupled to each other via a network 120. The devices 130A and 130B may be collectively referred to as “devices 130,” or generically referred to as a “device 130.” The e-commerce server 110 is a network-based system. The devices 130 may interact with the e-commerce server 110 using a web client 140A or an app client 140B. The e-commerce server 110 and the devices 130 may each be implemented in a computer system, in whole or in part, as described below with respect to FIGS. 13-14.

The e-commerce server 110 provides an electronic commerce application to other machines (e.g., the devices 130) via the network 120. The electronic commerce application provides a way for users to buy and sell items directly from and to each other, to buy from and sell to the electronic commerce application provider, or both. An item listing describes an item that can be purchased. For example, a user may create an item listing that describes an item owned by the user that may be purchased by another user via the e-commerce server 110. Item listings include text, one or more images, or both.

Also shown in FIG. 1 is a user 150. The user 150 may be a human user (e.g., a human being), a machine user (e.g., a computer configured by a software program to interact with the devices 130 and the e-commerce server 110), or any suitable combination thereof (e.g., a human assisted by a machine or a machine supervised by a human). The user 150 is not part of the network environment 100, but is associated with the devices 130 and may be a user of the devices 130 (e.g., an owner of the devices 130A and 130B). For example, the device 130 may be a desktop computer, a vehicle computer, a tablet computer, a navigational device, a portable media device, or a smart phone belonging to the user 150.

In some example embodiments, the e-commerce server 110 receives selections of items for purchase from a user (e.g., the user 150) and places the selected items in a virtual shopping cart. When the user indicates that he or she is ready to check out, the e-commerce server 110 determines a proposed assignment of discounts to the items in the shopping cart and causes a user interface to be presented on the device 130. The user interface may enable the user to approve the proposed assignment of discounts, to select an alternative assignment of discounts to the items in the shopping cart, or both.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 13-14. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The network 120 is any network that enables communication between or among machines, databases, and devices (e.g., the e-commerce server 110 and the devices 130). Accordingly, the network 120 may be a wired network, a wireless network (e.g., a mobile or cellular network), or any suitable combination thereof. The network 120 may include one or more portions that constitute a private network, a public network (e.g., the Internet), or any suitable combination thereof.

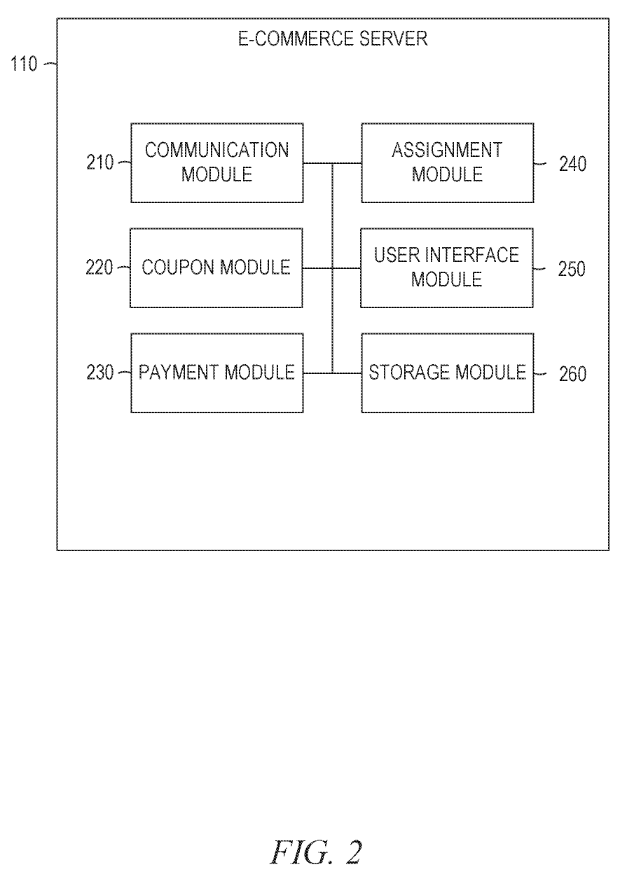

FIG. 2 is a block diagram illustrating components of the e-commerce server 110, according to some example embodiments. The e-commerce server 110 is shown as including a communication module 210, a coupon module 220, a payment module 230, an assignment module 240, a user interface module 250, and a storage module 260, all configured to communicate with each other (e.g., via a bus, shared memory, a switch, or application programming interfaces (APIs)). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 is configured to send and receive data. For example, the communication module 210 receives, over the network 120, selections of items for purchase by a user and sends the received data to the storage module 260 for later access by the assignment module 240, the user interface module 250, or both.

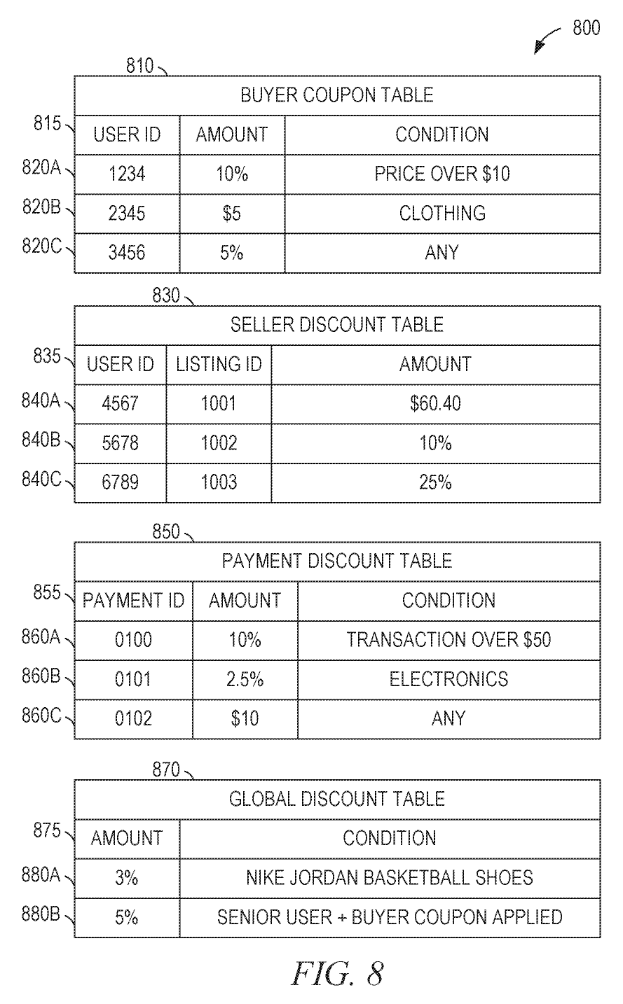

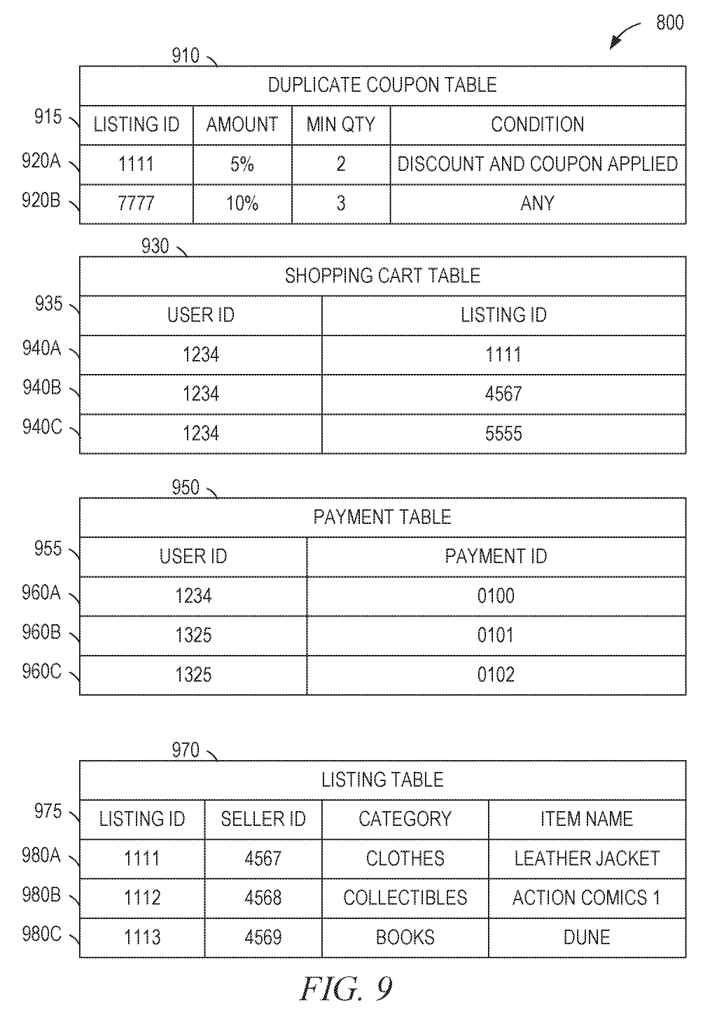

The coupon module 220 is configured to store coupon data in a database, retrieve coupon data from the database, or both. For example, the e-commerce server 110 is in communication with a server of a credit card company. The credit card server sends data to the e-commerce server 110 indicating that the credit card company will give a 1% discount on all purchases made using the company's credit cards before an end date. The coupon module 220 processes the received data and updates a database (e.g., a database using a database schema 800 discussed below with respect to FIGS. 8-9) to reflect the discount. During checkout by a user, the coupon module 220 retrieves the stored data reflecting the discount for application to the user's purchase.

The payment module 230 is configured to process payment from user accounts to the electronic marketplace served by the e-commerce server 110. For example, the payment module 230 totals the prices of items in a user's shopping cart, applies assigned discounts to the items, determines the total price to charge, and processes payment from a financial account of the user to one or more recipient financial accounts (e.g., a financial account of the electronic marketplace, one or more financial accounts of sellers of the items purchased by the user, or any suitable combination thereof).

The assignment module 240 is configured to assign discounts to items in a shopping cart. In some example embodiments, the assignment module 240 determines the assignments automatically for the payment module 230. In these embodiments, the assignment and payment operations are performed without further user involvement, once the user has requested purchase of the items in an associated shopping cart. In other example embodiments, the assignment module 240 generates one or more suggested assignment options for approval or modification by the user. In these embodiments, the payment module 230 handles payment after the user has selected, modified, or approved the assignment of coupons to the items in the shopping cart.

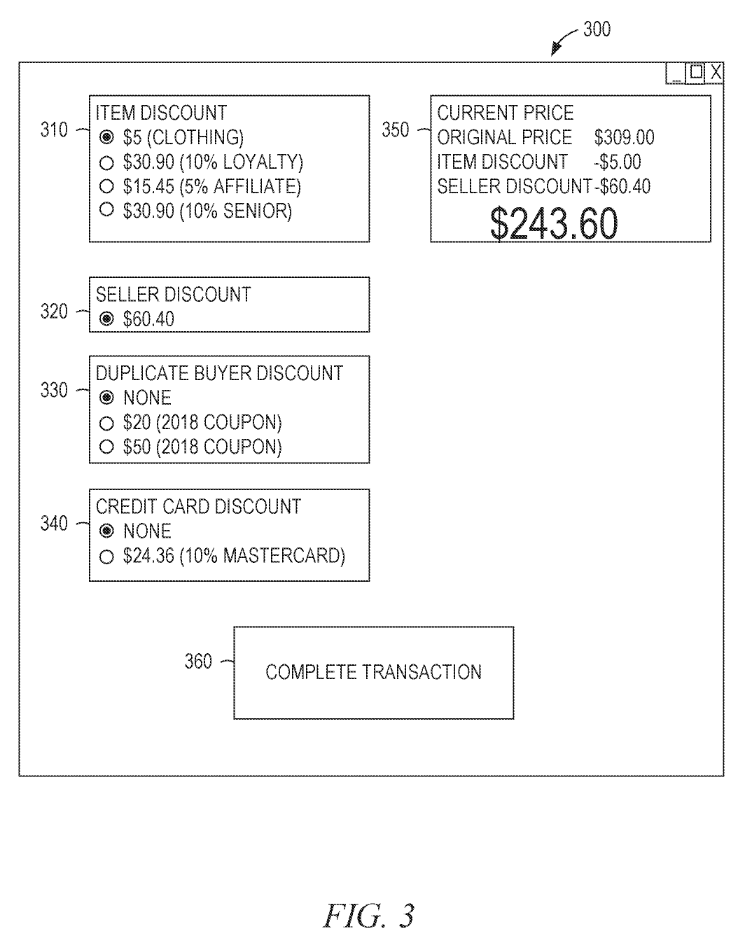

The user interface module 250 is configured to provide a user interface for selecting items for purchase, assigning coupons to items in a shopping cart, selecting a payment method, approving a proposed assignment of coupons to items, or any suitable combination thereof. For example, a user interface 300 (described below with respect to FIG. 3) is presented by the user interface module 250, and selections may be received via an application interface or a web interface, The storage module 260 is configured to store data regarding items, coupons, payment methods, users, or any suitable combination thereof.

FIG. 3 is a block diagram illustrating a user interface 300 suitable for accepting a recommended set of payment and discount options, according to some example embodiments. As can be seen in FIG. 3, the user interface 300 includes an item discount area 310, a seller discount area 320, a duplicate buyer discount area 330, a credit card discount area 340, a current price area 350, and a button 360.

The user interface 300 is displayed in response to a user initiating a checkout process after adding one or more items to a virtual shopping cart. The item discount area 310 shows a set of radio buttons. The user may select one radio button from the set of radio buttons in the item discount area 310 to request the corresponding discount. Each radio button includes a description showing the amount of the corresponding discount, an explanation of the type of discount, or both. In the example shown, the user may select one of a $5 fixed-amount discount applicable because the item is in a “clothing” category, a 10% loyalty discount based on a cumulative amount of purchases made by the user account on the electronic marketplace, a 5% affiliate discount based on a relationship between the user account and the electronic marketplace, or a 10% senior discount based on an age of a user associated with the user account.

The seller discount area 320 shows a single discount provided by the seller. In other example embodiments, the seller discount area 320, like the item discount area 310, contains multiple available discounts associated with the seller and the user may select one of the available discounts. In the example shown, the seller discount is a fixed amount of $60.40.

The duplicate buyer discount area 330 includes a set of radio buttons, with each radio button associated with a discount option or an option not to apply any discount. The duplicate buyer discounts may be applied in addition to the item discounts. By contrast, the item discounts are mutually exclusive, and a maximum of one item discount may be selected per item. In the example shown, the user has a $20 one-time-use coupon and a $50 one-time-use coupon, both for the year 2018.

The credit card discount area 340 also includes a set of radio buttons, with each radio button associated with a discount option associated with a payment type, or an option not to apply any discount. In the example shown, the user has a 10% discount available if payment is made using a MasterCard™.

The current price area 350 displays the current price of the item, including all assigned discounts. Thus, in the example shown, the item has an original price of $309.00, a $5.00 item discount is selected, a $60.40 seller discount is selected, and no duplicate buyer or credit card discounts are selected, yielding a current price of $243.60.

The button 360 is operable to complete the transaction, causing the amount indicated in the current price area 350 to be transferred from a financial account of the user. In some example embodiments, the user interface 300 is displayed for each item in the shopping cart. In other example embodiments, the elements of the user interface 300 are duplicated for each item in the shopping cart, allowing the user to select discounts for multiple items using a single screen.

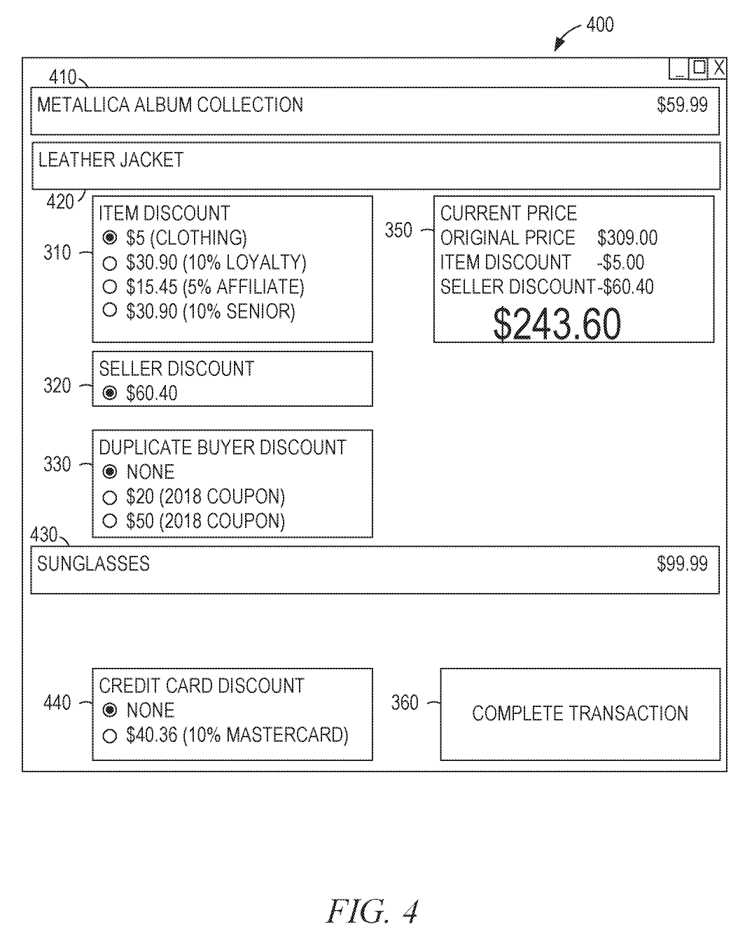

FIG. 4 is a block diagram illustrating a user interface 400 suitable for accepting a recommended set of payment and discount options, according to some example embodiments. As can be seen in FIG. 4, the user interface 400 includes item summaries 410 and 430, an item name 420, the item discount area 310, the seller discount area 320, the duplicate buyer discount area 330, the current price area 350, the credit card discount area 440, and the button 360. The user interface 400 may be displayed in response to a user initiating a checkout process after adding one or more items to a virtual shopping cart. The item summaries 410 and 430 each display a name of an item and a current price for the item. The item name 420 displays a name of an item. The item discount area 310, seller discount area 320, duplicate buyer discount area 330, current price area 350, and button 360 are described above with respect to FIG. 3, and are presented for an item corresponding to the item name 420. The credit card discount area 440 contains discount information related to the entire shopping cart.

Each item in the shopping cart may have a corresponding item summary (e.g., the item summary 410 or the item summary 430) or item name (e.g., the item name 420) in the user interface 400. By clicking on an item summary, a user causes an item discount area, a seller discount area, a duplicate buyer discount area, a current price area, or any suitable combination thereof to be displayed for the corresponding item. The displayed areas for another item may be hidden at the same time. For example, a user may click on the item summary 430, causing the areas 310, 320, 330, and 350 to be hidden and discount and price information for the sunglasses of the item summary 430 to be displayed.

The credit card discount area 440 may also include a set of radio buttons, with each radio button associated with a discount option associated with a payment type or an option not to apply any discount. in the example shown, the user has a 10% discount available if payment is made using a MasterCard™. By comparison with the credit card discount area 340, which shows a discount for a single item, the credit card discount area 440 shows a discount on the total price of items in the shopping cart.

The current price area 350 displays the current price of the item associated with the item name 420, including all assigned discounts. Thus, in the example shown, the item has an original price of $309.00, a $5.00 item discount is selected, a $60.40 seller discount is selected, and no duplicate buyer or credit card discounts are selected, yielding a current price of $243.60.

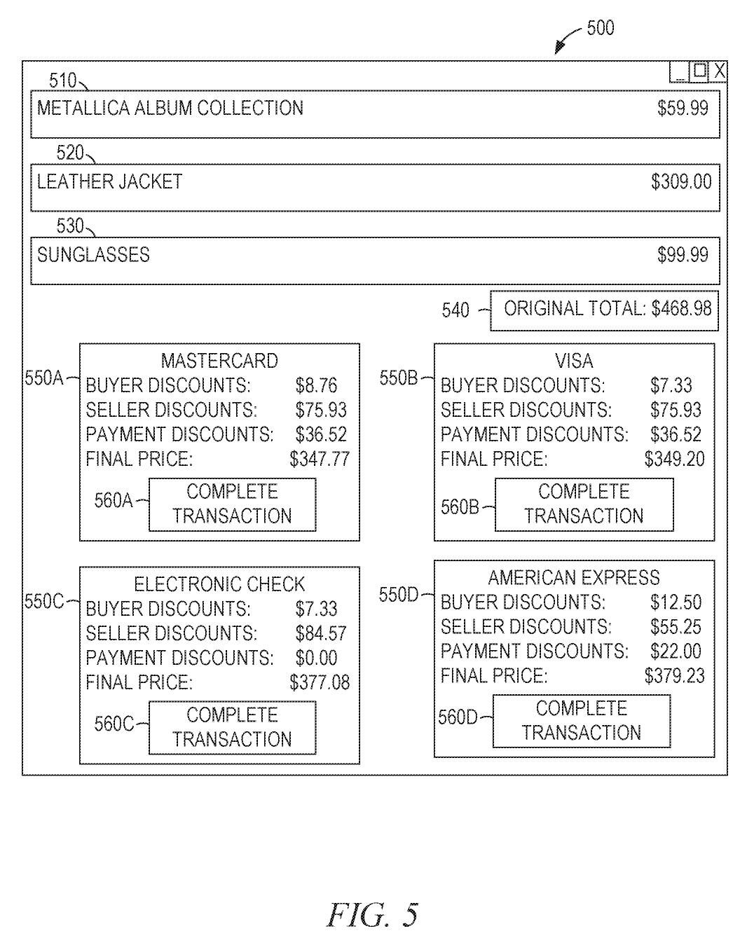

FIG. 5 is a block diagram illustrating a user interface 500 suitable for accepting a recommended set of payment and discount options, according to some example embodiments. As can be seen in 5, the user interface 500 includes item summaries 510, 520, and 530, an original total 540, payment option areas 550A, 550B, 550C, and 550D, and buttons 560A, 560B, 560C, and 560D. The user interface 500 may be displayed in response to a user initiating a checkout process after adding one or more items to a virtual shopping cart. The item summaries 510, 520, and 530 each display a name of an item and an original price for the item. The payment option areas 550A-550D each display buyer discounts, seller discounts, payment discounts, and a final price for the items in the shopping cart for a particular payment method. Each of the buttons 560A-560D is operable to complete the transaction using the corresponding particular payment method.

For example, the payment option area 550A shows the discounts and final price that result if the buyer pays for the transaction using a MasterCard™. The user may choose to complete the transaction using a MasterCard™ by operation of the button 560A. For example, a MasterCard™ account on file for the user may be charged for the amount shown as the final price in the payment option area 550A.

As another example, the payment option area 550C shows the discounts and final price that result if the buyer pays for the transaction using an electronic check. The user may choose to pay using an electronic check by operation of the button 560C. For example, a bank of the user may be notified of the transaction and directly transfer funds from the user's account to an account of the electronic marketplace, accounts of one or more sellers of the items in the user's shopping cart, or any suitable combination thereof.

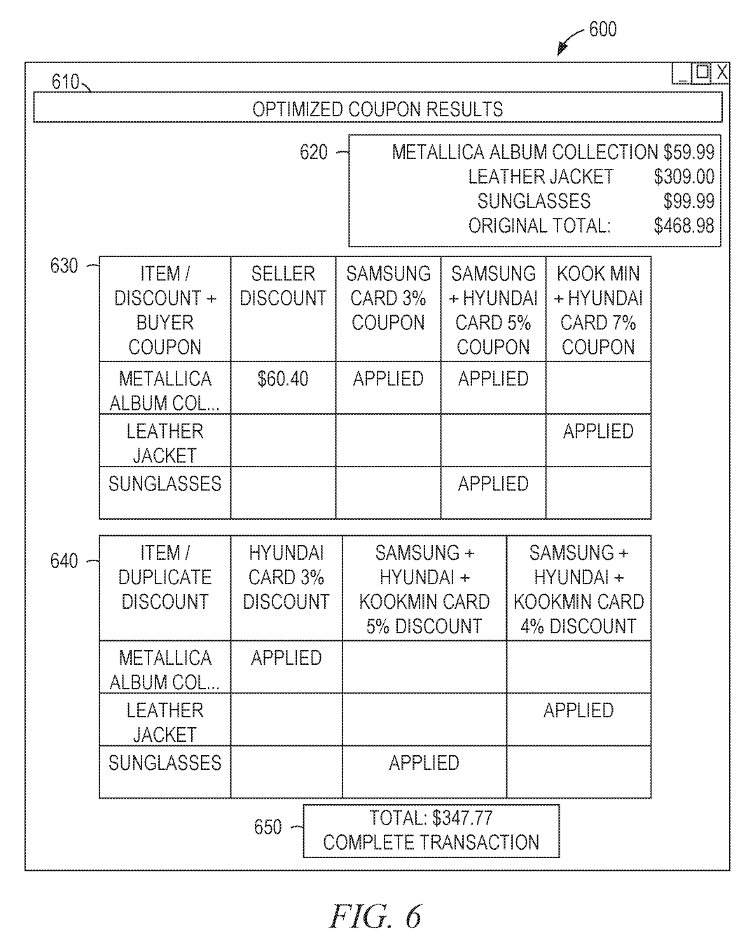

FIG. 6 is a block diagram illustrating a user interface 600 suitable for accepting a recommended set of payment and discount options, according to some example embodiments. As can be seen in FIG. 6, the user interface 600 includes a title 610, a shopping cart summary 620, a coupon table 630, a duplicate coupon table 640, and a button 650. The user interface 600 may be displayed in response to a user initiating a checkout process after adding one or more items to a virtual shopping cart. The title 610 displays a title for the user interface 600. The shopping cart summary 620 shows the names and undiscounted prices of items in a shopping cart, along with a total undiscounted price. The coupon table 630 shows the automatically generated assignment of coupons from a first set of coupons to items in the shopping cart. The duplicate coupon table 640 shows the automatically generated assignment of coupons from a set of duplicate coupons to items in the shopping cart. The button 650 is operable to complete the transaction using the automatically generated coupon assignments.

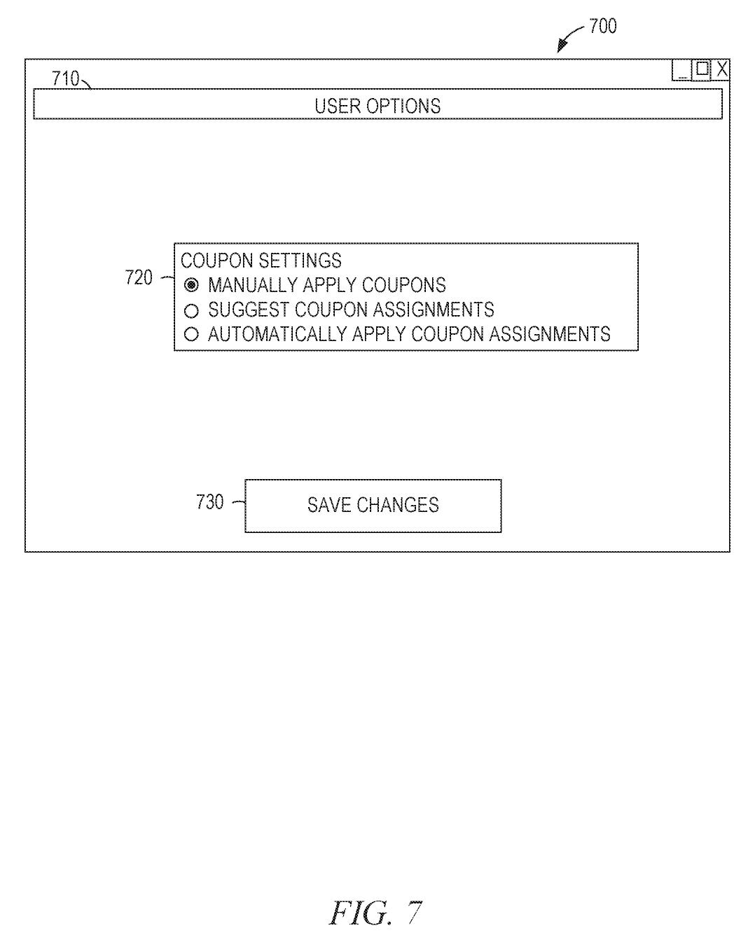

FIG. 7 is a block diagram illustrating a user interface 700 suitable for setting user options, according to some example embodiments. The user interface 700 includes a title 710, a coupon settings area 720, and a button 730. The user interface 700 may be displayed in response to a user choosing to review account settings or options. The title 710 displays a title for the user interface 700. The coupon settings area 720 displays options for assigning coupons to items in a shopping cart along with an indication of which option is currently active. The button 730 is operable to save any option changes and exit the user interface 700 (e.g., to return to selecting items on an electronic marketplace).

The options in the coupon settings area 720 allow the user to choose whether to manually assign coupons to items when checking out, to have the system suggest automatically generated coupon assignments but allow the user the opportunity to modify or accept the suggestions before checking out, or to have the system automatically generate and apply coupon assignments. With the last option selected, steps may be reduced during checkout, up to and including a one-click checkout option in which the user initiates checkout of items in a shopping cart, coupons are automatically assigned to the items in the shopping cart, a payment method is automatically selected, and the transaction is automatically completed. Stated another way, selection of the option to apply automatically generated assignments of coupons to items comprises an authorization or confirmation of recommended assignments prior to the generation of the recommended assignments.

FIG. 8 is a block diagram illustrating a database schema 800 suitable for a smart payment solution, according to some example embodiments. The database schema 800 includes a buyer coupon table 810, a seller discount table 830, a payment discount table 850, and a global discount table 870. The buyer coupon table 810 is defined by a table definition 815, including a user identifier field, an amount field, and a condition field, and includes rows 820A, 820B, and 820C. The seller discount table 830 is defined by a table definition 835, including a user identifier field, a listing identifier field, and an amount field, and includes rows 840A, 840B, and 840C. The payment discount table 850 is defined by a table definition 855, including a payment identifier field, an amount field, and a condition field, and includes rows 860A, 860B, and 860C. The global discount table 870 is defined by a table definition 875, including an amount field and a condition field, and includes rows 880A and 880B.

Each of the rows 820A-820C stores information for a buyer coupon. The user identifier field stores a username or other unique identifier for the user account that can use the buyer coupon. The amount field stores a percentage or fixed amount of the discount to be applied to the item on which the buyer coupon is used. The condition field stores a set of conditions that must be met in order for the buyer coupon to be used by the user account. Thus, the row 820A is for a buyer coupon of 10% off an item costing over $10; the row 820B is for a buyer coupon of $5 off an item in the “clothing” category; and the row 820C is for a buyer coupon of 5% off any item.

Each of the rows 840A-840C stores information for a seller discount. The user identifier field stores a username or other unique identifier for the user account providing the discount. The listing identifier field stores a unique identifier for the item to which the discount applies. The amount field stores a percentage or fixed amount of the discount to be applied to the item. Thus, the row 840A is for a discount of $60.40 for the listing 1001; the row 840B is for a discount of 10% for the listing 1002; and the row 840C is for a discount of 25% off the listing 1003.

The payment discount table 850 stores information for a discount based on a payment method. The payment identifier field stores an identifier for the payment method to which the discount applies. The amount field stores a percentage or fixed amount of the discount to be applied when the payment method is used. The condition field stores a set of conditions that must be met in order for the payment discount to be used, Thus, the row 860A is for a 10% discount when payment method 0100 (e.g., a MasterCard™ credit card) is used on a transaction totaling over $50; the row 860B is for a 2.5% discount when payment method 0101 (e.g., a Visa™ credit card) is used on an item in the “electronics” category; and the row 860C is for a $10 discount when payment method 0102 (e.g., a direct bank transfer) is used on any item.

Each of the rows 880A-880B of the global discount table 870 identifies an amount of a discount that applies to all buyers whenever the specified condition is met. Thus, the row 880A is for a 3% discount on any listing for Nike Jordan basketball shoes, and the row 880B is for a 5% discount for any senior user (e.g., a user over age 55) on an item to which a buyer coupon is applied.

FIG. 9 is a block diagram continuing the illustration of the database schema 800 suitable for a smart payment solution, according to some example embodiments. The database schema 800 includes a duplicate coupon table 910, a shopping cart table 930, a payment table 950, and a listing table 970. The duplicate coupon table 910 is defined by a table definition 915 and includes rows 920A and 920B. The shopping cart table 930 is defined by a table definition 935, including a user identifier field and a listing identifier field, and includes rows 940A, 940B, and 940C. The payment table 950 is defined by a table definition 955, including a user identifier field and a payment identifier field, and includes rows 960A, 960B, and 960C. The listing table 970 is defined by a table definition 975, including a listing identifier field, a seller identifier field, a category field, and an item name field, and includes rows 980A, 980B, and 980C.

The duplicate coupon table 910 stores information for discounts that apply when multiple items are purchased from a single listing. Each of the rows 920A-920B includes an identifier of the listing to which the discount applies, an amount of the discount, a minimum quantity required for purchase for the discount to apply, and any additional conditions required for the discount. Thus, the row 920A is for a 5% discount when at least two items are purchased from the listing 1111 and another discount and coupon are applied to the items. The row 920B is for a 10% discount when at least three items are purchased from the listing 7777, without any other conditions being imposed.

Each of the rows 940A-940C stores information for an item in a shopping cart. The user identifier field stores a username or other unique identifier for the user account for the shopping cart. The listing identifier field stores a unique identifier for the item in the shopping cart. Thus, the rows 940A-940C show three items in a shopping cart for a single user, since the user identifier in each row is the same.

Each of the rows 960A-960C stores information for a payment option for a user. The user identifier field stores a username or other unique identifier for the user account to which the payment option applies. The payment identifier field stores a unique identifier for the payment type, an account for the payment option, or both. For example, the payment identifier may indicate that the identified user has a MasterCard but not include the account number, which may be stored in another table or requested from the user during checkout. As another example, the payment identifier may include one or more of the user's MasterCard™ card number, the user's card verification code (CVC), an expiration date of the card, and a mailing address associated with the credit card account.

Each of the rows 980A-980C stores information for a listing of an item for sale. The listing identifier field stores a unique identifier for the listing, and may be referenced by the shopping cart table 930, the seller discount table 830, or other tables. The seller identifier field stores a unique identifier for the seller of the item, and may be referenced by the seller discount table 830, a user table, or other tables. The category field stores an identifier for one or more categories of the item, and may be a name of the category or an identifier to be used as an index to a category table. The category field may be referenced by the condition field of the buyer coupon table 810, the payment discount table 850, the global discount table 870, or the duplicate coupon table 910, to indicate that a particular discount applies only to listings within an identified category. The item name field identifies a name of the item (e.g., for use in the user interface 400 or the user interface 500). In various example embodiments, additional fields may be present, such as an item description field, an item image field, a date of creation field, an expiration date field, a starting price field, a buy-it-now price field, a current bid field, a bidder identifier field, a shipping price field, or any suitable combination thereof.

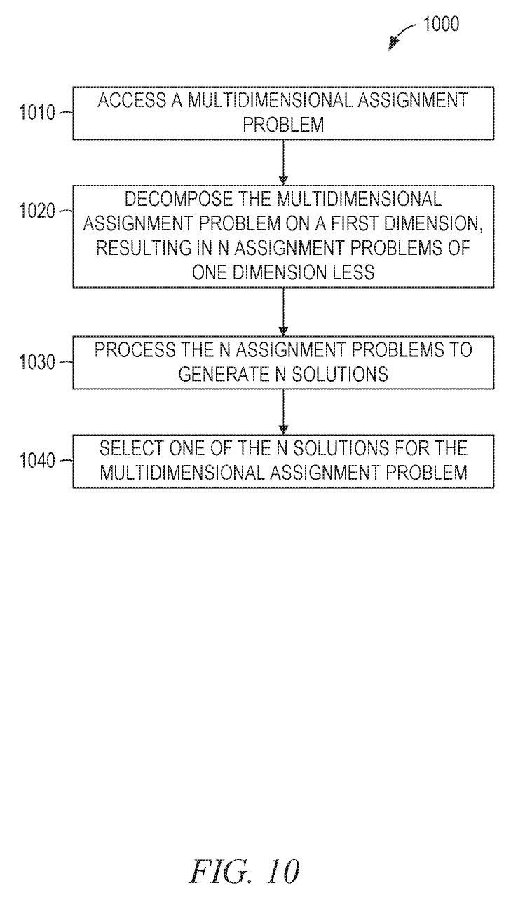

FIG. 10 is a flowchart illustrating operations of a computing device in performing a method 1000 of generating a solution to a multidimensional assignment problem, according to some example embodiments. Operations in the method 1000 may be performed by the e-commerce server 110, using modules described above with respect to FIG. 2.

In operation 1010, the assignment module 240 accesses a multidimensional assignment problem. A multidimensional assignment problem is one in which elements of each of multiple sets are to be assigned to elements of another set. The dimensionality of the multidimensional assignment problem is equal to the number of the multiple sets to be assigned. For example, assigning a set of coupons to a set of items for purchase, with no other assignments involved, is a single-dimensional assignment problem. Assigning, to a set of items, a set of coupons associated with a buyer, a set of coupons associated with a seller, and a payment method from a set of payment methods is a three-dimensional assignment problem. The multidimensional assignment problem may be an optimization problem, in which each assignment has a value to be maximized or minimized. In some example embodiments, the optimization problem optimizes a cost or a discount.

Accessing the multidimensional assignment problem may comprise accessing first data representing a first plurality of first items of a first type (e.g., a database table representing a plurality of items for purchase by a user), accessing second data representing a second plurality of second items of a second type (e.g., a database table representing a plurality of buyer coupons for the user, subject to assignment rules, such as being limited to one coupon per item for purchase), and accessing third data representing a third plurality of third items of a third type (e.g., a database table representing a plurality of payment options for the user). In some example embodiments, accessing the multidimensional assignment problem may comprise accessing fourth data representing a fourth plurality of fourth items of a fourth type (e.g., a database table representing a plurality of duplicate buyer coupons for the user, subject to different assignment rules than the second plurality of second items of the second type, such as not being limited to one coupon per item for purchase)

In operation 1020, the assignment module 240 decomposes the multidimensional assignment problem on a first dimension, resulting in N assignment problems of one dimension less. N is the number of possible assignments of the first dimension. For example, the three-dimensional assignment problem discussed above may be decomposed on the dimension of the payment method, resulting in N two-dimensional assignment problems. If separate payment options are allowed for each item, N is the number of members of the set of payment methods multiplied by the number of members of the set of items for purchase.

If one payment option is to be used for the entire purchase, N is the number of members of the set of payment methods. in this example, an assignment problem is created to assign the second plurality of second items of the second type (e.g., the plurality of buyer coupons for the user) to the first plurality of first items of the first type (e.g., the plurality of items for purchase by the user), for each of the items of the third plurality of third items of the third type (e.g., for each payment option of the plurality of payment options for the user).

In operation 1030, the assignment module 240 processes the N assignment problems to generate N solutions. Continuing with the above example, in which one payment method is to be selected for the entire purchase, N assignments of the set of coupons associated with the buyer and the set of coupons associated with the seller are generated for the set of items for purchase, one for each of the N payment methods. Each of the N solutions may have a corresponding value as an optimization measure. For example, each solution may have a corresponding discount that results from the assignment of the coupons to the items when the payment method is used.

In some example embodiments, the N assignment problems are executed in parallel. For example, the N assignment problems may be divided among multiple cores, processors, or devices, reducing the amount of time elapsed between creation of the N assignment problems and their solution when compared to executing the N assignment problems in series. In many cases, decomposing the original multidimensional assignment problem into N assignment problems and solving the N assignment problems is faster than solving the original multidimensional assignment problem directly. The N assignment problems may be solved using the Hungarian algorithm or other linear programming techniques,

As previously noted, each of the N assignment results corresponds to a possible assignment of items on the dimension used for decomposition of the original multidimensional assignment problem. For the specific example of decomposing the multidimensional assignment problem into one assignment problem for each of the items of the third plurality of third items of the third type (e.g., for each payment option available to the user), each of the N solutions corresponds to one item of the third plurality of third items.

In operation 1040, the assignment module 240 selects one of the N solutions for the multidimensional assignment problem. For example, the optimization measures of each of the N solutions may be compared and the solution having the maximum (or minimum) value may be selected along with the corresponding assignment of items used on the dimension used for decomposition. Thus, the payment method and coupon assignments may be selected that maximize the discount to be applied and minimize the total cost of the set of items to be purchased.

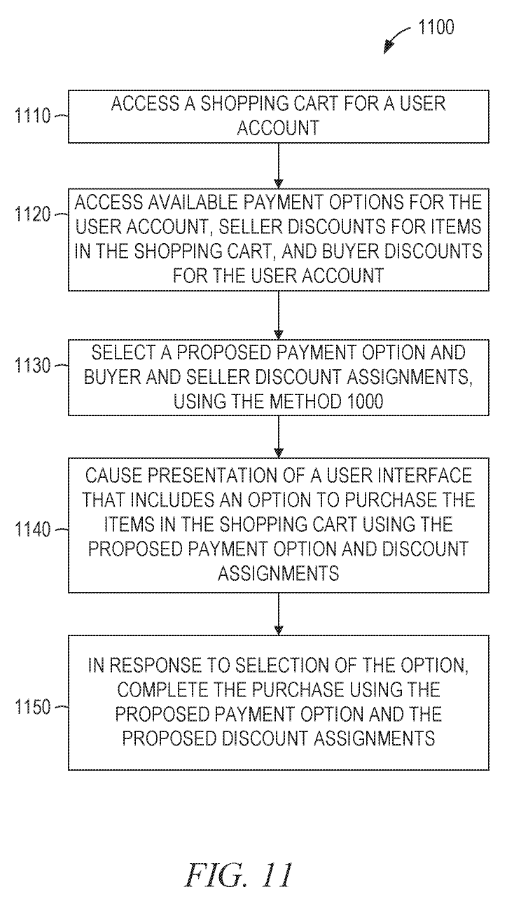

FIG. 11 is a flowchart illustrating operations of an e-commerce server in performing a method 1100 of recommending a set of payment and discount options, according to some example embodiments. Operations in the method 1100 may be performed by the e-commerce server 110, using modules described above with respect to FIG. 2. For example, the e-commerce server 110 may receive a request from a user to check out in an online marketplace, wherein the request to check out is associated with a shopping cart (e.g., via the shopping cart table 930) and the shopping cart comprises items for purchase.

In operation 1110, the assignment module 240 accesses a shopping cart for a user account. The shopping cart identifies, from a database (e.g., using the shopping cart table 930 and the listing table 970), a set of items selected for purchase by the user account. Data for each item may include a seller identifier, a category for the item, a sales price, or any suitable combination thereof.

In operation 1120, the assignment module 240 accesses (e.g., based on a user identifier for the user account) available payment options for the user account, seller discounts for items in the shopping cart, and buyer discounts for the user account. For example, records in the buyer coupon table 810 having a user identifier corresponding to the user account of the buyer are accessed, records in the seller discount table 830 having a user identifier corresponding to the user account of the seller and a listing identifier corresponding to an item in the shopping cart are accessed, and records in the payment table 950 having a user identifier corresponding to the user account of the buyer are accessed.

In operation 1130, the assignment module 240 uses the method 1000 to select a proposed payment option and buyer and seller discounts. For example, a multidimensional assignment problem may be created, wherein the solution to the problem is a single payment option for the shopping cart and a set of assignments of buyer and seller discounts to the items in the shopping cart. The method 1000 may be used to determine the solution to the multidimensional assignment problem that yields the largest discount.

In operation 1140, the user interface module 250 causes presentation of a user interface that includes an option to purchase the items in the shopping cart using the proposed payment option and discounts. For example, the user interface 300 or the user interface 400 may be shown.

In operation 1150, the payment module 230, in response to selection of the option to purchase the items, completes the purchase (e.g., completes a sales transaction) using the proposed payment option and the proposed selection of discount assignments. Thus, money may be transferred from a financial account of the buyer to one or more financial accounts of one or more sellers of items in the shopping cart, records for one-time-use discounts may be removed from the buyer coupon table 810, the seller discount table 830, and the payment discount table 850, or any suitable combination thereof.

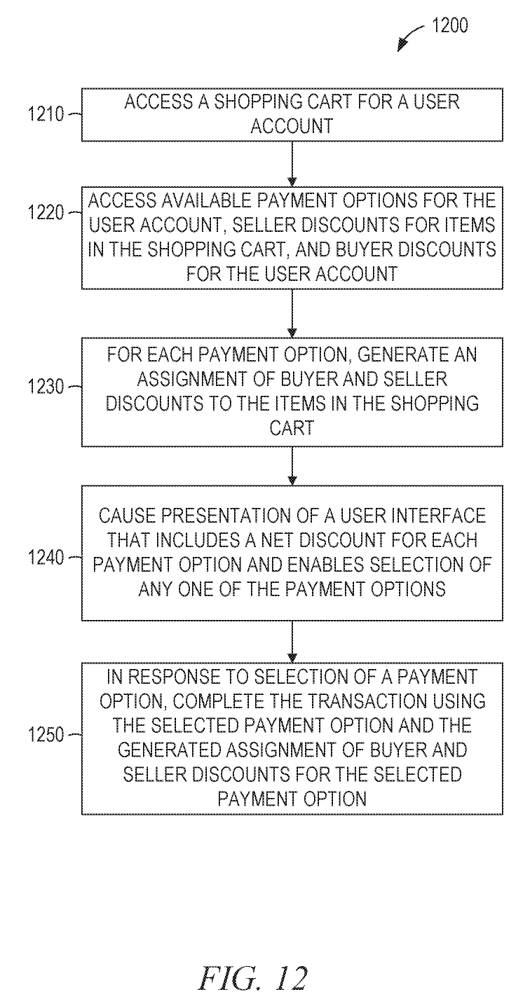

FIG. 12 is a flowchart illustrating operations of an e-commerce server in performing a method 1200 of recommending a set of payment and discount options, according to some example embodiments. Operations in the method 1200 may be performed by the e-commerce server 110, using modules described above with respect to FIG. 2.

In operation 1210, the assignment module 240 accesses a shopping cart for a user account. The shopping cart identifies, from a database, a set of items selected for purchase by the user account. Data for each item may include a seller identifier, a category for the item, a sales price, or any suitable combination thereof.

In operation 1220, the assignment module 240 accesses available payment options for the user account, seller discounts for items in the shopping cart, and buyer discounts for the user account. For example, records in the buyer coupon table 810 having a user identifier corresponding to the user account of the buyer are accessed, records in the seller discount table 830 having a user identifier corresponding to the user account of the seller and a listing identifier corresponding to an item in the shopping cart are accessed, and records in the payment table 950 having a user identifier corresponding to the user account of the buyer are accessed.

In operation 1230, the assignment module 240 generates, for each payment option, a proposed assignment of buyer and seller discounts to the items in the shopping cart. For example, N assignment problems are generated, one for each payment option, and the N assignment problems are processed using operation 1030 of the method 1000 to generate N solutions, each solution providing the largest total discount for one payment option.

In operation 1240, the user interface module 250 causes presentation of a user interface that includes a net discount for each payment option and enables selection of any one of the payment options. For example, the user interface 500 of FIG. 5 may be shown.

In operation 1250, the payment module 230, in response to selection of a payment option, completes the transaction using the selected payment option and the generated assignment of buyer and seller discounts for the selected payment option. Thus, money may be transferred from a financial account of the buyer to one or more financial accounts of one or more sellers of items in the shopping cart, records for one-time-use discounts may be removed from the buyer coupon table 810, the seller discount table 830, and the payment discount table 850, or any suitable combination thereof.

According to various example embodiments, one or more of the methodologies described herein may facilitate efficient application of discounts to items purchased from an electronic marketplace. Hence, one or more of the methodologies described herein may facilitate applying discounts to items without requiring the user to manually determine the discount assignments. More generally, the methods of decomposing multidimensional assignment problems and solving each of the resulting problems in parallel may find application in a variety of contexts, including industrial, clean technology, biotechnology, and mechanical contexts.

When these effects are considered in aggregate, one or more of the methodologies described herein may obviate a need for certain efforts or resources that otherwise would be involved in assigning discounts to items. Efforts expended by a user in assigning discounts may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

Certain embodiments are described herein as including logic or a number of components, modules, or mechanisms. Modules may constitute either software modules (e.g., code embodied on a non-transitory machine-readable medium) or hardware-implemented modules. A hardware-implemented module is a tangible unit capable of performing certain operations and may be configured or arranged in a certain manner. in example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application programming interfaces (APIs)).

### Electronic Apparatus and System

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special-purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Software Architecture

FIG. 13 is a block diagram 1300 illustrating a software architecture 1302, which may be installed on any one or more of the devices described above. FIG. 13 is merely a non-limiting example of a software architecture, and it will be appreciated that many other architectures may be implemented to facilitate the functionality described herein. The software architecture 1302 may be implemented by hardware such as a machine 1400 of FIG. 14 that includes processors 1410, memory 1430, and I/O components 1450. In this example, the software architecture 1302 may be conceptualized as a stack of layers where each layer may provide a particular functionality. For example, the software architecture 1302 includes layers such as an operating system 1304, libraries 1306, frameworks 1308, and applications 1310. Operationally, the applications 1310 invoke application programming interface (API) calls 1312 through the software stack and receive messages 1314 in response to the API calls 1312, according to some implementations.

In various implementations, the operating system 1304 manages hardware resources and provides common services. The operating system 1304 includes, for example, a kernel 1320, services 1322, and drivers 1324. The kernel 1320 acts as an abstraction layer between the hardware and the other software layers in some implementations. For example, the kernel 1320 provides memory management, processor management (e.g., scheduling), component management, networking, and security settings, among other functionality. The services 1322 may provide other common services for the other software layers. The drivers 1324 may be responsible for controlling or interfacing with the underlying hardware. For instance, the drivers 1324 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1306 provide a low-level common infrastructure that may be utilized by the applications 1310. The libraries 1306 may include system libraries 1330 (e.g., C standard library) that may provide functions such as memory allocation functions, string manipulation functions, mathematic functions, and the like. In addition, the libraries 1306 may include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGI, framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1306 may also include a wide variety of other libraries 1334 to provide many other APIs to the applications 1310.

The frameworks 1308 provide a high-level common infrastructure that may be utilized by the applications 1310, according to some implementations. For example, the frameworks 1308 provide various graphic user interface (GUI) functions, high-level resource management, high-level location services, and so forth. The frameworks 1308 may provide a broad spectrum of other APIs that may be utilized by the applications 1310, some of which may be specific to a particular operating system or platform.

In an example embodiment, the applications 1310 include a home application 1350, a contacts application 1352, a browser application 1354, a book reader application 1356, a location application 1358, a media application 1360, a messaging application 1362, a game application 1364, and a broad assortment of other applications such as a third-party application 1366. According to some embodiments, the applications 1310 are programs that execute functions defined in the programs. Various programming languages may be employed to create one or more of the applications 1310, structured in a variety of manners, such as object-orientated programming languages (e.g., Objective-C, Java, or C++) or procedural programming languages (e.g., C or assembly language). In a specific example, the third-party application 1366 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1366 may invoke the API calls 1312 provided by the mobile operating system (e.g., the operating system 1304) to facilitate functionality described herein.

### Example Machine Architecture and Machine-Readable Medium

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1416 (e.g., software, a program, an application, an applet, an app, or other executable code) for causing the machine 1400 to perform any one or more of the methodologies discussed herein may be executed. In alternative embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1416, sequentially or otherwise, that specify actions to be taken by the machine 1400. Further, while only a single machine 1400 is illustrated, the term “machine” shall also be taken to include a collection of machines 1400 that individually or jointly execute the instructions 1416 to perform any one or more of the methodologies discussed herein.

The machine 1400 may include processors 1410, memory 1430, and I/O components 1450, which may be configured to communicate with each other via a bus 1402. In an example embodiment, the processors 1410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 1412 and a processor 1414 that may execute the instructions 1416. The term “processor” is intended to include multi-core processors that may comprise two or more independent processors (also referred to as “cores”) that may execute instructions contemporaneously. Although FIG. 14 shows multiple processors, the machine 1400 may include a single processor with a single core, a single processor with multiple cores (e.g., a multi-core processor), multiple processors with a single core, multiple processors with multiple cores, or any combination thereof,

The memory 1430 may include a main memory 1432, a static memory 1434, and a storage unit 1436 accessible to the processors 1410 via the bus 1402. The storage unit 1436 may include a machine-readable medium 1438 on which are stored the instructions 1416 embodying any one or more of the methodologies or functions described herein. The instructions 1416 may also reside, completely or at least partially, within the main memory 1432, within the static memory 1434, within at least one of the processors 1410 (e.g., within the processor's cache memory), or any suitable combination thereof, during execution thereof by the machine 1400. Accordingly, in various implementations, the main memory 1432, the static memory 1434, and the processors 1410 are considered machine-readable media 1438.

As used herein, the term “memory” refers to a machine-readable medium 1438 able to store data temporarily or permanently and may be taken to include, but not be limited to, random-access memory (RAM), read-only memory (ROM), buffer memory, flash memory, and cache memory. While the machine-readable medium 1438 is shown in an example embodiment to be a single medium, the term “machine-readable medium” should be taken to include a single medium or multiple media (e.g., a centralized or distributed database, or associated caches and servers) able to store the instructions 1416. The term “machine-readable medium” shall also be taken to include any medium, or combination of multiple media, that is capable of storing instructions (e.g., instructions 1416) for execution by a machine (e.g., machine 1400), such that the instructions, when executed by one or more processors of the machine (e.g., processors 1410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1450 include a wide variety of components to receive input, provide output, produce output, transmit information, exchange information, capture measurements, and so on. In general, it will be appreciated that the I/O components 1450 may include many other components that are not shown in FIG. 14. The I/O components 1450 are grouped according to functionality merely for simplifying the following discussion and the grouping is in no way limiting. In various example embodiments, the I/O components 1450 include output components 1452 and input components 1454. The output components 1452 include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1454 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 1450 include biometric components 1456, motion components 1458, environmental components 1460, or position components 1462, among a wide array of other components. For example, the biometric components 1456 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1458 include acceleration sensor components accelerometer), gravitation sensor components, rotation sensor components (e.g., gyroscope), and so forth. The environmental components 1460 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1462 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1450 may include communication components 1464 operable to couple the machine 1400 to a network 1480 or devices 1470 via a coupling 1482 and a coupling 1472, respectively, For example, the communication components 1464 include a network interface component or another suitable device to interface with the network 1480. In further examples, the communication components 1464 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1470 may be another machine or any of a wide variety of peripheral devices (e.g., a peripheral device coupled via a USB).

Moreover, in some implementations, the communication components 1464 detect identifiers or include components operable to detect identifiers. For example, the communication components 1464 include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 1464, such as location via Internet Protocol (IP) geolocation, location via Wi-Fi® signal triangulation, location via detecting an NEC beacon signal that may indicate a particular location, and so forth.

### Transmission Medium

In various example embodiments, one or more portions of the network 1480 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1480 or a portion of the network 1480 may include a wireless or cellular network and the coupling 1482 may be a Code Division Multiple Access (CDMA) connection, a Global System for Mobile communications (GSM) connection, or another type of cellular or wireless coupling. In this example, the coupling 1482 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 1416 are transmitted or received over the network 1480 using a transmission medium via a network interface device (e.g., a network interface component included in the communication components 1464) and utilizing any one of a number of well-known transfer protocols (e.g., Hypertext Transfer Protocol (HTTP)). Similarly, in other example embodiments, the instructions 1416 are transmitted or received using a transmission medium via the coupling 1472 (e.g., a peer-to-peer coupling) to the devices 1470. The term “transmission medium” shall be taken to include any intangible medium that is capable of storing, encoding, or carrying the instructions 1416 for execution by the machine 1400, and includes digital or analog communications signals or other intangible media to facilitate communication of such software.

Furthermore, the machine-readable medium 1438 is non-transitory (in other words, not having any transitory signals) in that it does not embody a propagating signal. However, labeling the machine-readable medium 1438 as “non-transitory” should not be construed to mean that the medium is incapable of movement; the medium should be considered as being transportable from one physical location to another. Additionally, since the machine-readable medium 1438 is tangible, the medium may be considered to be a machine-readable device.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
accessing, by one or more processors, a user profile associated with a set of payment methods, the user profile being associated with a user;
receiving, by one or more processors, a selection of a plurality of items for purchase by the user;
accessing, by one or more processors, information for a plurality of coupons;
causing a user interface to be displayed on a display device of the user, the user interface comprising:
for each payment method of the set of payment methods, a total cost for the plurality of items;
a recommended payment method selected from the set of payment methods; and
a recommended assignment of the coupons to the items;
receiving, by one or more processors, a confirmation from the user; and
initiating a purchase transaction for the items by the user, the purchase transaction using the recommended payment method and the recommended assignment of the coupons to the items.

2. The method of claim 1, wherein the receiving of the confirmation from the user comprises receiving the confirmation before the causing of the display of the recommended payment method and the recommended assignment of the items to the coupons.

3. The method of claim 1, wherein each coupon of the plurality of coupons may be assigned to a maximum of one of the items.

4. The method of claim 1, further comprising:
receiving a request from the user to check out in an online marketplace, the request to check out being associated with a shopping cart, the shopping cart comprising the items for purchase.

5. The method of claim 1, further comprising:
selecting the recommended payment method and the recommended assignment of the coupons to the items by:
for each payment method, creating, based on the payment method, an optimization problem to optimize assignment of the coupons to the items;
executing, by one or more processors, the created optimization problems in parallel to generate a set of optimization results, each optimization result including a possible assignment of the coupons to the items for a payment method; and
based on the set of optimization results, selecting one of the optimization results.

6. The method of claim 5, wherein the executing of the created optimization problems in parallel comprises solving the optimization problems using the Hungarian algorithm. The method of claim 1, wherein at least one payment method of the set of payment methods is a credit card payment method.

8. The method of claim 1, wherein:
the receiving of the confirmation from the user comprises receiving the confirmation via the user interface; and
the initiating of the purchase transaction is in response to the receiving of the confirmation.

9. A system comprising:
a memory that stores instructions; and
one or more processors configured by the instructions to perform operations comprising:
accessing a user profile associated with a set of payment methods, the user profile being associated with a user;
receiving a selection of a plurality of items for purchase by the user;
accessing information for a plurality of coupons;
causing a user interface to be displayed on a display device of the user, the user interface comprising:
for each payment method of the set of payment methods, a total cost for the plurality of items;
a recommended payment method selected from the set of payment methods; and
a recommended assignment of the coupons to the items;
receiving a confirmation from the user; and
initiating a purchase transaction for the items by the user, the purchase transaction using the recommended payment method and the recommended assignment of the coupons to the items.

10. The system of claim 9, wherein the receiving of the confirmation from the user comprises receiving the confirmation before the recommended payment method and recommended assignment of the items to the coupons are displayed.

11. The system of claim 9, wherein each coupon of the plurality of coupons may be assigned to a maximum of one of the items.

12. The system of claim 9, wherein the operations further comprise:
receiving a request from the user to check out in an online marketplace, the request to check out being associated with a shopping cart, the shopping cart comprising the items for purchase.

13. The system of claim 9, further comprising:
selecting the recommended payment method and the recommended assignment of the coupons to the items by:
for each payment method, creating, based on the payment method, an optimization problem to optimize assignment of the coupons to the items;
executing the created optimization problems in parallel to generate a set of optimization results, each optimization result including a possible assignment of the coupons to the items for a payment method; and
based on the set of optimization results, selecting one of the optimization results.

14. The system of claim 13, wherein the executing of the created optimization problems in parallel comprises solving the optimization problems using the Hungarian algorithm.

15. The system of claim 9, wherein at least one payment method of the set of payment methods is a credit card payment method.

16. A non-transitory machine-readable medium comprising instructions that, when executed by one or more processors of a machine, cause the machine to perform operations comprising:
accessing a user profile associated with a set of payment methods, the user profile being associated with a user;
receiving a selection of a plurality of items for purchase by the user;
accessing information for a plurality of coupons;
causing a user interface to be displayed on a display device of the user, the user interface comprising:
for each payment method of the set of payment methods, a total cost for the plurality of items;
a recommended payment method selected from the set of payment methods; and
a recommended assignment of the coupons to the items;
receiving a confirmation from the user; and
initiating a purchase transaction for the items by the user, the purchase transaction using the recommended payment method and the recommended assignment of the coupons to the items.

17. The non-transitory machine-readable medium of claim 16, wherein the receiving of the confirmation from the user comprises receiving the confirmation before the recommended payment method and recommended assignment of the items to the coupons are displayed.

18. The non-transitory machine-readable medium of claim 16, wherein each coupon of the plurality of coupons may be assigned to a maximum of one of the items.

19. The non-transitory machine-readable medium of claim 16, wherein the operations further comprise:
receiving a request from the user to check out in an online marketplace, the request to check out being associated with a shopping cart, the shopping cart comprising the items for purchase.

20. The non-transitory machine-readable medium of claim 16, wherein the operations further comprise:
selecting the recommended payment method and the recommended assignment of the coupons to the items by:
for each payment method, creating, based on the payment method, an optimization problem to optimize assignment of the coupons to the items;
executing the created optimization problems in parallel to generate a set of optimization results, each optimization result including a possible assignment of the coupons to the items for a payment method; and
based on the set of optimization results, selecting one of the optimization results.
